(19) United States
(12) Patent Application Publication
(10) Pub. No.: US 2023/0177166 A1
(43) Pub. Date: Jun. 8, 2023

(54) Security Vulnerability Detection

(71) Applicant: SAP SE, Walldorf (DE)

(72) Inventors: Souphiane Bensalim, Darmstadt (DE); Thomas Barber, Stutensee (DE); David Klein, Braunschweig (DE); Martin Johns, Braunschweig (DE)

(21) Appl. No.: 17/542,939

(22) Filed: Dec. 6, 2021

(51) Int. Cl. G06F 21/57

(52) U.S. Cl. CPC G06F 21/577; G06F 2221/033

(57) ABSTRACT

Embodiments relate to improving accuracy of security vulnerability detection by determining a context of a data flow from a target, generating an exploit, and injecting the exploit based upon the context to create a vulnerable Uniform Resource Locator (URL). The context may comprise a HTML context, a URL context, a JavaScript context, or a JSON context. Communication of the vulnerable URL to a testing platform results in validation of the presence of a security vulnerability. Embodiments may find particular value in detecting vulnerability to a client-side XSS attack, by generating a vulnerable URL containing an exploit that is injected based upon a collected taint flow. Where the target is a website, embodiments improve accuracy of client-side XSS validation exploits by identifying which characters of a URL enter a specific context (e.g., HTML or JavaScript), and replacing these characters with a payload designed to trigger code execution for validation.

### BACKGROUND

Unless otherwise indicated herein, the approaches described in this section are not prior art to the claims in this application and are not admitted to be prior art by inclusion in this section.

Sites on the world wide web are increasingly the subject of attacks by malicious third parties. Cross-Site Scripting (XSS) is one form of security vulnerability, in which malicious scripts are injected into a web application in order to transfer sensitive data to the hostile third party entity. XSS vulnerabilities offer one of the most prevalent ongoing security risks, and may be found in almost two thirds of all applications.

### SUMMARY

Embodiments relate to improving accuracy of security vulnerability detection by determining a context of a data flow from a target, generating an exploit, and injecting the exploit based upon the context to create a vulnerable Uniform Resource Locator (URL). The context may comprise a HTML context, a URL context, a JavaScript context, or a JSON context. Communication of the vulnerable URL to a testing platform results in validation of the presence of a security vulnerability. Embodiments may find particular value in detecting vulnerability to a client-side XSS attack, by generating a vulnerable URL containing an exploit that is injected based upon a JSON context. Where the target is a website, embodiments improve accuracy of client-side XSS validation exploits by identifying which characters of a URL enter a specific context (e.g., HTML or JavaScript), and replacing these characters with a payload designed to trigger code execution for validation.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 is a simplified block diagram of an example system.

FIG. 4 shows an example data flow.

FIG. 5 shows a simplified illustration of an example of exploit generation.

FIG. 6 illustrates hardware of a special purpose computing machine configured to perform security vulnerability detection.

FIG. 7 illustrates an example computer system.

### DETAILED DESCRIPTION

Described herein are methods and apparatuses that provide detection of security vulnerabilities. In the following description, for purposes of explanation, numerous examples and specific details are set forth in order to provide a thorough understanding of embodiments. It will be evident, however, to one skilled in the art that embodiments as defined by the claims may include some or all of the features in these examples alone or in combination with other features described below, and may further include modifications and equivalents of the features and concepts described herein.

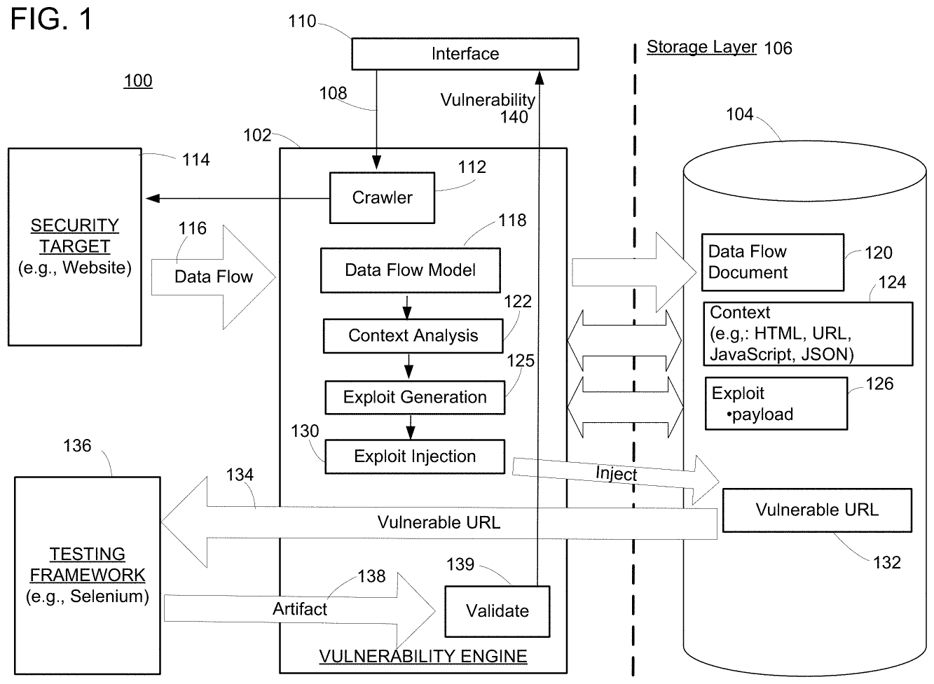

FIG. 1 shows a simplified view of an example system that is configured to implement security vulnerability detection according to an embodiment.

Specifically, system 100 comprises vulnerability engine 102 in communication with a non-transitory computer readable storage medium 104 that is located in a storage layer 106. The vulnerability engine is configured to receive instructions 108 via a user interface 110.

In response to these instructions, a crawler 112 is configured to access a security target 114. The target produces a data flow 116 that is communicated back to the vulnerability engine.

The vulnerability engine receives the data flow. With reference to a model 118, the engine stores the data flow as a document 120 within the storage medium.

Then, the vulnerability engine performs an analysis 122 of the data flow document to determine a context 124. As discussed in detail below, this context can be a HTML context, a URL context, a JavaScript context, or a JSON context.

Next, based upon the context, the vulnerability engine generates 125 an exploit 126. The exploit is stored within the storage layer and includes a payload 128, whose execution can reveal the existence of a security vulnerability such as a cross-site scripting attack.

Next, based upon the determined context, the vulnerability engine performs injection 130 of the generated exploit to create a vulnerable URL 132. The vulnerability engine then communicates 134 the vulnerable URL to a testing framework 136—one possible example of which is SELENIUM.

The testing framework processes the vulnerable URL. As part of this testing, the payload of the injected exploit may result an artifact 138 (such as JavaScript execution) whose presence reveals the existence of a security vulnerability (such as to a XSS attack).

The artifact is received by the vulnerability engine. Based upon receipt of the artifact, the vulnerability engine validates 139 the existence of a security vulnerability 140, and communicates that vulnerability back to the interface (e.g., to alert a user to the security issue).

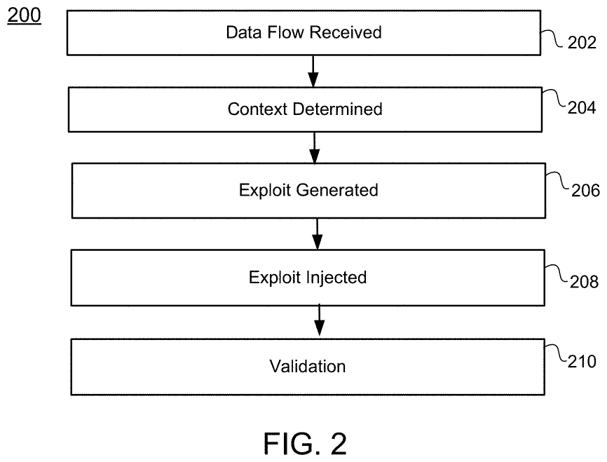

FIG. 2 is a flow diagram of a method 200 according to an embodiment. At 202, a data flow is received.

At 204, a context of a data flow is determined. At 206, an exploit is generated based upon the context.

At 208, the exploit is injected into the data flow based upon the context to create a vulnerable URL. At 210, the vulnerable URL is communicated for testing to validate the existence of a vulnerability.

Further details regarding security vulnerability detection according to various embodiments, are now provided in connection with the following example.

### Example

Client-side XSS represents one type of XSS attack. Client-side XSS has emerged as a security concern, as web applications have transitioned from traditional static webpages to feature-rich client-side JavaScript rendering in the browser.

In order to exploit a client-side XSS vulnerability, the attacker builds a link containing a crafted malicious script. Hence, the attacker concentrates on vulnerabilities that are issuing from the URL and landing into a context that allows code execution.

In client-side XSS, the script execution occurs while a webpage is being loaded or after it is loaded. Thus, the malicious script is not inserted into the webpage on the server side, but instead on the client-side.

The web browser does not differentiate between a safe script issued from the developer, and a malicious script injected by an attacker. Client-side XSS is caused by insecure data-flows present in client-side code, in which data from user-controlled source functions flows into functions which allow script execution in the Document Object Model (DOM)—known as sink functions.

Accordingly, this exemplary embodiment offers an automated system providing:
1) detection of potentially insecure data-flows in web applications,
2) generation of client-side XSS exploits, and
3) validation of those client-side XSS exploits.

In particular, dynamic taint tracking is used to generate client-side XSS exploits. Exploits are generated in a context-aware manner.

The exploits are then injected into the URL, in a position where it is most likely to result in successful code execution. For validation of security vulnerabilities, generated URLs are tested to see whether they lead to arbitrary JavaScript execution.

Embodiments may relate to the script execution contexts with the HTML or JavaScript context. Embodiments improve end-to-end performance by selecting an injection point in order to generate exploits which are more likely to be vulnerable.

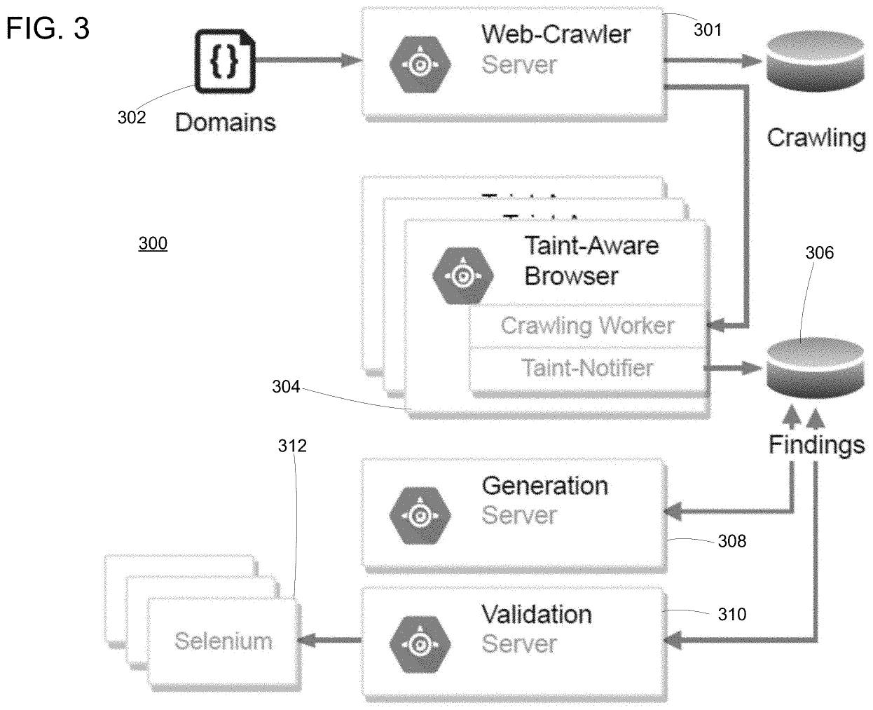

FIG. 3 illustrates an example architecture for a system 300 configured for detection of potential client-side XSS vulnerabilities.

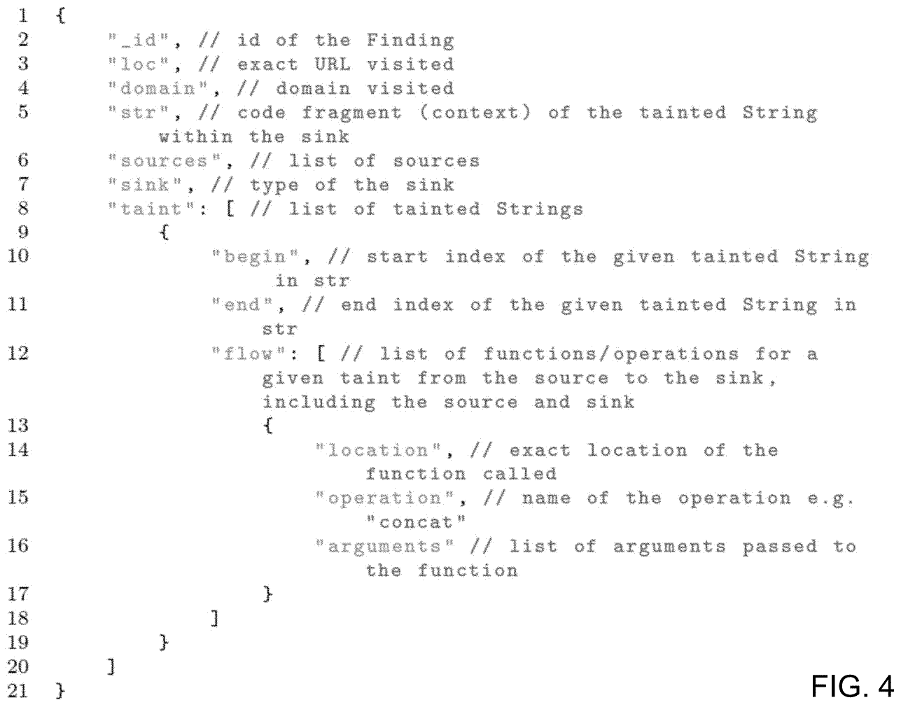

For detection of vulnerabilities, the crawler 301 visits specific web pages 302 to collect potentially insecure data flows using dynamic taint tracking implemented in the taint-aware browser 304. An example data flow resulting from the detection phase in this approach is shown in FIG. 4.

In particular, FIG. 4 is a JSON Model for a document stored in the Findings collection 306 before generating the exploits. Each tainted string is extracted within its context and saved in the sink property.

The range of the tainted string in that context is then given by the taint[i].begin and taint[i].end properties. This allows to correctly identify the tainted string within the source and the sink.

For exploit generation 308, exploit URLs are generated from the appropriate data-flows which could lead to a client-side XSS exploit.

For validation 310 of security vulnerabilities, generated URLs are tested by the Selenium testing platform 312. Resulting arbitrary execution of a JavaScript, validates the existence of a XSS vulnerability on the client side.

Context-sensitive exploit generation according to this particular example, is now described in detail. In order to exploit a client-side XSS vulnerability, an attacker has to build a URL containing a crafted malicious exploit.

In general, an XSS exploit comprises three parts as follows:

exploit:=breakOut+payload+breakIn

The first part of the exploit is the breakOut sequence. The purpose of this sequence is to “break out” of a non-executable context, to a context where JavaScript can be executed.

The second part is the payload comprising the script code that is to be executed. The third part is the breakIn sequence. This serves to escape any subsequent code sequences in order to prevent them from causing execution errors.

The parts of an exploit depend on the script execution context. Determining that context is important for an effective exploit generation, as each context has different exploitation criteria.

Specifically, this exemplary embodiment can generate exploits for the following four (4) different contexts.

1. HTML Context: It is possible for web applications to inject HTML code directly into the document of the page. In case the injected code originates from a user-controlled source, client-side XSS is possible.

Within the HTML context, there is the injection into the HTML content, and the injection into the HTML attributes. For injection into the HTML content, JavaScript allows the dynamic creation and modification of DOM Elements on a webpage (via, e.g., document.write and innerHTML).

For injection into the HTML attributes, if the attribute is an HTML5 Event Handler the code can be injected directly into the attribute and will be executed when the event occurs. Otherwise, the context should be first closed in order to inject either an Event Handler inside the same tag or reach an HTML Content context and inject a script.

2. URL Context: In the URL context, a user-controlled input is injected into a URL attribute of certain DOM elements. Even if HTML encoding prevents breaking out of the HTML context, there is still a potential threat. The attacker can, for example, make use of the:
javascript:,
data:, and/or
vbscript
   scheme in order to run the malicious script if they are able to control the whole attribute.

3. JavaScript Context: Web applications which turn user provided input into executable code—via, e.g., eval( )—are also at risk of client-side XSS. These functions take the code in string format, and execute it as JavaScript.

Template literals are another type of JavaScript context that allows embedded JavaScript expressions using the { . . . } syntax to be evaluated.

4. JSON Context: In the JSON context, a user-controllable input is reflected as a JavaScript Object Notation (JSON) value. JSON is commonly used to serialize and transmit data within and between Web applications. This context can be exploited by breaking out from the JSON context into the JavaScript context and then injecting malicious code.

URL Injection Technique

The URL Injection Technique is now described. Once an exploit is created, it is to be inserted into the URL in a position which is most likely to result in execution of the payload.

Embodiments use the information about the tainted flow to resolve the context where it appears within the URL. Then, embodiments can define the corresponding range of characters to be replaced. To calculate this range, the following (six) indices may be defined.

beginTaintURL and endTaintURL: These represent the start and the end indices of the tainted string in the URL. They are computed by searching for the tainted string within the URL.

replaceBeginURL and replaceEndURL: These represent the start and the end indices of the part of the tainted string that can be replaced without causing the application to perform in an unexpected way. The following three different cases are treated here.

A. Completely replace the tainted String: This is the case where the tainted String is completely within the query Strings, the fragment or within both of them.

replaceBeginURL:=beginTaintURL

replaceEndURL:=endTaintURL

B. Partially replace the tainted String: In this case, the tainted String includes a part of the path and also a part from the query String or the fragment or both. Here, a change in the path or sometimes in a query parameter name is not wanted in order to preserve the correctness of the URL, just the part after the path has to be replaced.

replaceBeginURL:=(indexOf(‘?’)+1)∥(indexOf(‘#’)+1)

replaceEndURL:=endTaintURL

C. Don't replace the tainted String: This is the case where the tainted String has no characters within the query Strings and the fragment. In this case, a replace is not allowed, the URL is just appended with the generated exploit.

replaceBeginURL:=location·length

replaceEndURL:=location·length

replaceBeginParam and replaceEndParam: These indices correspond to replaceBeginURL and replaceEndURL within the sink context. They are used in the exploit generation to analyze the preceding code and generate a correct breakOut. The determination of them follows also the same three cases mentioned before.

### A. Completely Replace the Tainted String.

replaceBeginParam:=taint·begin

replaceEndParam:=taint·end

### B. Partially Replace the Tainted String.

replaceBeginParam:=taint·begin+[(location·indexOf(‘?’)+1)∥(location·indexOf(‘#’)+1)]−beginTaintURL

relaceEndParam:=taint·end

### C. Don't Replace the Tainted String.

replaceBeginParam:=taint·end

replaceEndParam:=taint·end

In a final step, the generated exploit is inserted into the URL. The generated exploit replaces the characters between the replaceBeginURL and replaceEndURL indices.

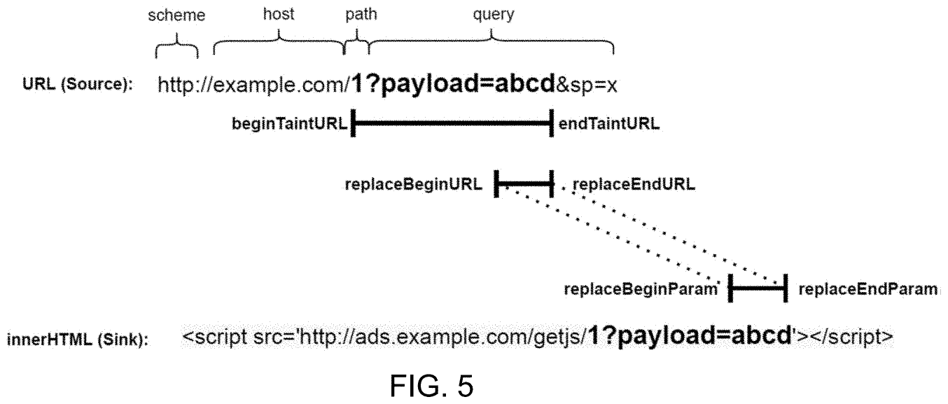

FIG. 5 shows an example of targeted exploit injection. Using the calculated indices, the string “abcd” is identified as replaceable. It is therefore replaced with the generated exploit in a next step, allowing a precise injection into the query string value.

Embodiments may offer one or more benefits for the detection and defense against security threats. In particular, to counter client-side XSS attacks, encoding and sanitizing the data coming from a user-controlled input is advised, as browsers may not have protection.

However, such encoding/sanitizing can be an error prone process if performed manually by the individual developer, as many contexts exist and each has its own mitigation policy. Therefore, employing embodiments as described herein on top of the encoding and sanitizing functions, can function to improve the security of applications.

Another potential benefit is increased accuracy of security threat detection. Rather than appending payloads to the end of the URL and relying on heuristics to trigger code execution, embodiments are targeted to replace characters which are replacing in a sink function.

While the instant example has focused upon detecting a client-side XSS security vulnerabilities, embodiments are not limited to this. Other types of security vulnerabilities could be detected utilizing approaches as disclosed herein, including but not limited to:
Server-side XSS;
SQL injection.

In conclusion, embodiments afford consideration of flows coming from a location source, and landing to an execution sink. Embodiments allow tracking of the taint flows (sources, sinks, and taint operations) present in a visited web application page, using dynamic taint tracking. Embodiments provide context sensitive generation of exploits for vulnerable URLs, allowing precise exploit injection into a location. Validation of the generated URLs may be achieved by checking whether they lead to arbitrary JavaScript execution.

Embodiments may generate client-side XSS exploits with certain benefits. One possible benefit is improved precision of exploit injection, increasing the rate of correctly generated exploits.

Another possible benefit is improved performance. In particular, by eliminating the safe URLs in an early stage, only the relevant flows are inspected for exploit generation.

Still another possible benefit is the extension of context. That is, embodiments are able to consider the JSON context, with JSON emerging as a predominant Web technology.

Returning to FIG. 1, there the particular embodiment is depicted with the vulnerability engine as being located outside of the database. However, this is not required.

Rather, alternative embodiments could leverage the processing power of an in-memory database engine (e.g., the in-memory database engine of the HANA in-memory database available from SAP SE), in order to perform various functions as described above.

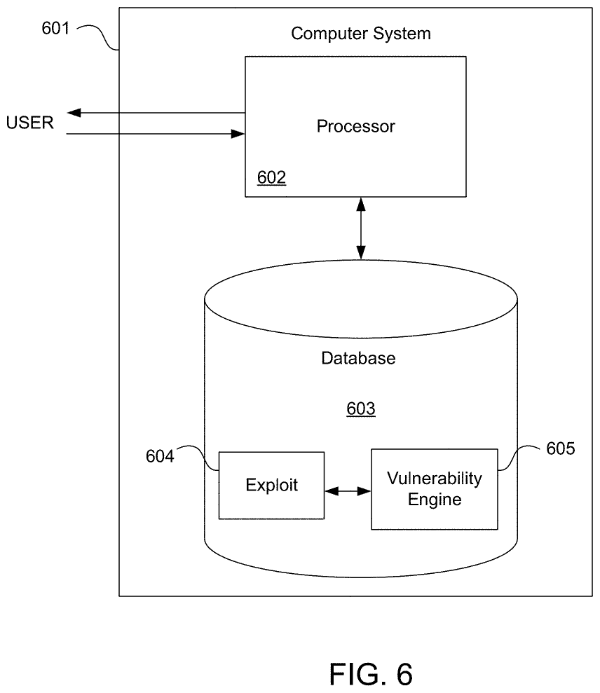

Thus FIG. 6 illustrates hardware of a special purpose computing machine configured to implement security vulnerability detection according to an embodiment. In particular, computer system 601 comprises a processor 602 that is in electronic communication with a non-transitory computer-readable storage medium comprising a database 603. This computer-readable storage medium has stored thereon code 605 corresponding to a vulnerability engine. Code 604 corresponds to an exploit. Code may be configured to reference data stored in a database of a non-transitory computer-readable storage medium, for example as may be present locally or in a remote database server.

Software servers together may form a cluster or logical network of computer systems programmed with software programs that communicate with each other and work together in order to process requests.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented system and methods comprising:
receiving a data flow from a security target;
determining a context of the data flow;
generating an exploit based upon the context;
storing the exploit in a non-transitory computer readable storage medium;
injecting the exploit into the data flow based upon the context, to create a vulnerable Uniform Resource Locator (URL);
communicating the vulnerable URL to a testing platform;
receiving an artifact from the testing platform;
validating a security vulnerability in response to the artifact; and
communicating the security vulnerability to an interface.

Example 2. The computer implemented system and method of Example 1 wherein the context comprises HTML context, URL context, JavaScript context, or JSON context.

Example 3. The computer implemented system and method of Examples 1 or 2 wherein the artifact is execution of JavaScript.

Example 4. The computer implemented system and method of Examples 1, 2, or 3 wherein generating the exploit is based upon a pair of indices.

Example 5. The computer implemented system and method of Examples 1, 2, 3, or 4 wherein the non-transitory computer readable storage medium comprises an in-memory database; and
determining the context is performed by an in-memory database engine of the in-memory database.

Example 6. The computer implemented system and method of Examples 1, 2, 3, 4, or 5 wherein the security vulnerability comprises a cross-site scripting (XSS) vulnerability.

Example 7. The computer implemented system and method of Example 6 wherein the XSS vulnerability comprises a client-side XSS vulnerability.

Example 8. The computer implemented system and method of Example 6 wherein the XSS vulnerability comprises a server-side XSS vulnerability.

Example 9. The computer implemented system and method of Examples 1, 2, 3, 4, or 5 wherein the security vulnerability comprises a SQL injection vulnerability.

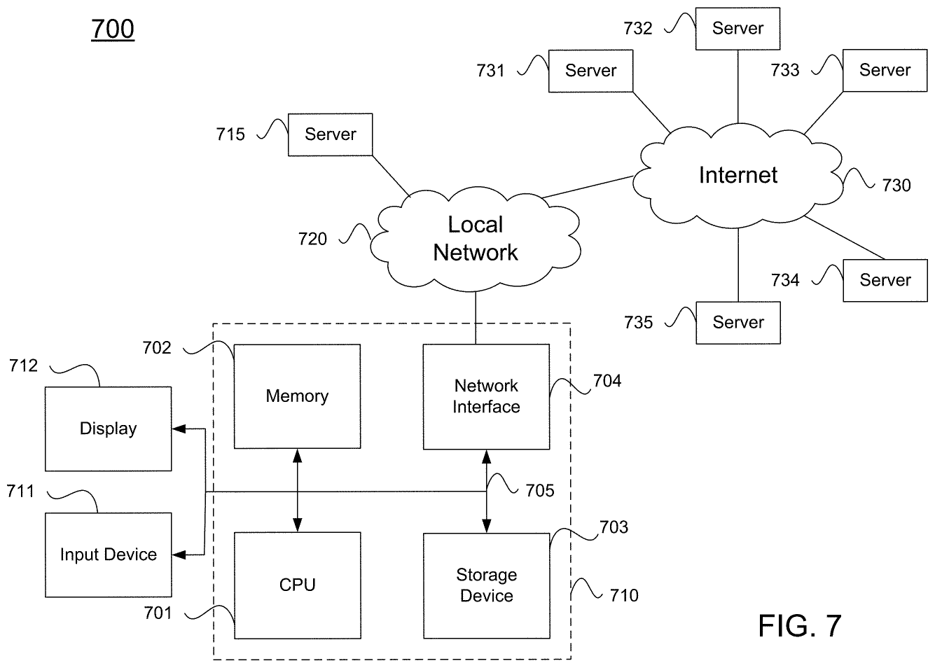

An example computer system 700 is illustrated in FIG. 7. Computer system 710 includes a bus 705 or other communication mechanism for communicating information, and a processor 701 coupled with bus 705 for processing information. Computer system 710 also includes a memory 702 coupled to bus 705 for storing information and instructions to be executed by processor 701, including information and instructions for performing the techniques described above, for example. This memory may also be used for storing variables or other intermediate information during execution of instructions to be executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 703 may include source code, binary code, or software files for performing the techniques above, for example. Storage device and memory are both examples of computer readable mediums.

Computer system 710 may be coupled via bus 705 to a display 712, such as a Light Emitting Diode (LED) or liquid crystal display (LCD), for displaying information to a computer user. An input device 711 such as a keyboard and/or mouse is coupled to bus 705 for communicating information and command selections from the user to processor 701. The combination of these components allows the user to communicate with the system. In some systems, bus 705 may be divided into multiple specialized buses.

Computer system 710 also includes a network interface 704 coupled with bus 705. Network interface 704 may provide two-way data communication between computer system 710 and the local network 720. The network interface 704 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 704 sends and receives electrical, electromagnetic, or optical signals that carry digital data streams representing various types of information.

Computer system 710 can send and receive information, including messages or other interface actions, through the network interface 704 across a local network 720, an Intranet, or the Internet 730. For a local network, computer system 710 may communicate with a plurality of other computer machines, such as server 715. Accordingly, computer system 710 and server computer systems represented by server 715 may form a cloud computing network, which may be programmed with processes described herein. In the Internet example, software components or services may reside on multiple different computer systems 710 or servers 731-735 across the network. The processes described above may be implemented on one or more servers, for example. A server 731 may transmit actions or messages from one component, through Internet 730, local network 720, and network interface 804 to a component on computer system 710. The software components and processes described above may be implemented on any computer system and send and/or receive information across a network, for example.

The above description illustrates various embodiments along with examples of how aspects of embodiments may be implemented. The above examples and embodiments should not be deemed to be the only embodiments, and are presented to illustrate the flexibility and advantages of embodiments as defined by the following claims. Based on the above disclosure and the following claims, other arrangements, embodiments, implementations and equivalents will be evident to those skilled in the art and may be employed without departing from the spirit and scope of the embodiments as defined by the claims.

What is claimed is:

1. A method comprising:
receiving a data flow from a security target;
determining a context of the data flow;
generating an exploit based upon the context;
storing the exploit in a non-transitory computer readable storage medium;
injecting the exploit into the data flow based upon the context, to create a vulnerable Uniform Resource Locator (URL);
communicating the vulnerable URL to a testing platform;
receiving an artifact from the testing platform;
validating a security vulnerability in response to the artifact; and
communicating the security vulnerability to an interface.

2. A method as in claim 1 wherein the security vulnerability comprises a cross-site scripting (XSS) vulnerability.

3. A method as in claim 2 wherein the XSS vulnerability comprises a client-side XSS vulnerability.

4. A method as in claim 2 wherein the XSS vulnerability comprises a server-side XSS vulnerability.

5. A method as in claim 1 wherein the security vulnerability comprises a SQL injection vulnerability.

6. A method as in claim 1 wherein the context comprises HTML context.

7. A method as in claim 1 wherein the context comprises URL context.

8. A method as in claim 1 wherein the context comprises JavaScript context.

9. A method as in claim 1 wherein the context comprises JSON context.

10. A method as in claim 1 wherein the artifact is execution of JavaScript.

11. A method as in claim 1 wherein generating the exploit is based upon a pair of indices.

12. A method as in claim 1 wherein:
the non-transitory computer readable storage medium comprises an in-memory database; and
determining the context is performed by an in-memory database engine of the in-memory database.

13. A non-transitory computer readable storage medium embodying a computer program for performing a method, said method comprising:
receiving a data flow from a security target;
determining a context of the data flow;
generating an exploit based upon the context;
storing the exploit in a non-transitory computer readable storage medium;
injecting the exploit into the data flow based upon the context, to create a vulnerable Uniform Resource Locator (URL);
communicating the vulnerable URL to a testing platform;
receiving an artifact from the testing platform;
validating a cross-site scripting (XSS) security vulnerability in response to the artifact; and
communicating the XSS security vulnerability to an interface.

14. A non-transitory computer readable storage medium as in claim 13 wherein the XSS security vulnerability is a client-side XSS vulnerability.

15. A non-transitory computer readable storage medium as in claim 14 wherein the context comprises a HTML context, a URL context, a JavaScript context, or a JSON context.

16. A non-transitory computer readable storage medium as in claim 13 wherein generating the exploit is based upon a pair of indices.

17. A computer system comprising:
one or more processors;
a software program, executable on said computer system, the software program configured to cause an in-memory database engine of an in-memory database to:
receive a data flow from a security target;
determine a context of the data flow;
generate an exploit based upon the context;
store the exploit in the in-memory database;
inject the exploit into the data flow based upon the context, to create a vulnerable Uniform Resource Locator (URL);
communicate the vulnerable URL to a testing platform;
receive an artifact from the testing platform;
validate a security vulnerability in response to the artifact; and
communicate the security vulnerability to an interface.

18. A computer system as in claim 17 wherein the security vulnerability is a client-side cross-site scripting (XSS) vulnerability, a server-side cross-site scripting (XSS) vulnerability, or a SQL injection vulnerability.

19. A computer system as in claim 17 wherein the context is a HTML context, a URL context, a JavaScript context, or a JSON context.

20. A computer system as in claim 17 wherein the exploit is generated based upon a pair of indices.
